(19) United States
(12) Patent Application Publication
(10) Pub. No.: US 2015/0106161 A1
(43) Pub. Date: Apr. 16, 2015

(54) RETAIL SALES FORECASTING WITH OVERLAPPING PROMOTIONS EFFECTS

(71) Applicant: Oracle International Corporation, Redwood Shores, CA (US)

(72) Inventors: Catalin POPESCU, Atlanta, GA (US); Lin HE, Johns Creek, GA (US); Ming LEI, Atlanta, GA (US); Chun TANG, Alpharetta, GA (US)

(21) Appl. No.: 14/051,670

(22) Filed: Oct. 11, 2013

(51) Int. Cl. G06Q 30/02

(52) U.S. Cl. CPC G06Q 30/0202
USPC 705/7.31

(57) ABSTRACT

A system that generates a sales forecast for an item receives sales history for prior sales periods that include active promotion events that are active during each sales period. The system determines one or more types of overlapping promotions during the sales periods. For each type of overlapping promotion, the system creates an overlapping promotion event that replaces the corresponding active promotion events. The system generates a set of promotion events including the overlapping promotion events and the active promotion events that were not replaced. The system then generates a lift for each of the promotion events in the set of promotion events.

### FIELD

One embodiment is directed generally to a computer system, and in particular to a computer system that forecasts sales of retail items.

### BACKGROUND INFORMATION

Retailers frequently initiate promotions to boost sales and ultimately increase profit. There are many types of promotions that a retailer may initiate depending on the time frame and the type of retail items. Examples of possible promotions for retail items include temporary price cuts, rebates, advertisements in a newspaper or a website or via email, coupons, special placement of items in a store, etc. For some items, multiple promotions are active at the same time, referred to as “overlapping promotions”. For example, a particular brand and size of soda may be featured in a supermarket flyer, may be given a special up-front shelf space, and may be offered at a temporary 60% discount. All three of these promotions may occur during the same time frame.

Retailers must also formulate sales forecasts. For the purpose of replenishment, planning, and allocation, the retailer needs to have an estimate of how much of an item is likely to be sold at a store for a given number of days or weeks. However, retail sales forecasting is a very complex problem to solve as the number of items for a large retailer can easily be in the hundreds of thousands, the number of stores in the thousands, and the number of forecasting time periods in the tens. The resulting number of forecast data points can be in the billions. The problem becomes even more complex when the forecast needs to incorporate the effects of events such as promotions.

### SUMMARY

One embodiment is a system that generates a sales forecast for an item. The system receives sales history for prior sales periods that include active promotion events that are active during each sales period. The system determines one or more types of overlapping promotions during the sales periods. For each type of overlapping promotion, the system creates an overlapping promotion event that replaces the corresponding active promotion events. The system generates a set of promotion events including the overlapping promotion events and the active promotion events that were not replaced. The system then generates a lift for each of the promotion events in the set of promotion events.

### BRIEF DESCRIPTION OF THE DRAWINGS

FIG. 1 is a block diagram of a computer server/system in accordance with an embodiment of the present invention.

FIG. 2 is a flow diagram of the functionality of the overlapping promotions module of FIG. 1 when determining the effects of overlapping promotions for retail forecasting in accordance with one embodiment.

### DETAILED DESCRIPTION

One embodiment is a system that generates promotion combination events in addition to traditional promotion events. The promotion combination events are separate events for when promotions overlap and replace the overlapping promotion events. The promotion combination events and traditional promotion events are then used as variables in a stepwise linear regression to determine a retail store sales forecast.

In general, an “overlapping promotion” is an instance where an item and retail store location combination has multiple promotions active for the same time period. One way the overlapping promotions can be accounted for in retail forecasting (i.e., forecasting a lift over a baseline forecast in response to a promotion) is to estimate the effects of each promotion independently, and use a weight when applying each promotion to a baseline forecast. The weighted promotions are then used as variables in a stepwise linear regression algorithm to determine the retail forecast.

For example, promotion A may have an estimated lift of a 20% increase in demand, while promotion B may have an estimated lift of a 30% increase in demand. If the two promotions are active in the same time period, then the total lift may be: (0.7×0.2)+(0.7×0.3)=35%,

where a weight of 0.7 was applied to the individual lifts to account for the fact that two promotions were overlapping.

Another alternative for accounting for overlapping promotions is using the following formula:

combined lift=square root of the sum of lift_of_promo_{—}A squared and lift_of_promo_{—}B squared

Using the numbers from the above example: combined lift=sqrt(0.2̂2+0.3̂2)=36%

However, there are multiple drawbacks to these methods. For one, the promotional lifts are estimated from data points where the promotions may have occurred by themselves, or may have been overlapping other promotions. This usually distorts the estimate value. Further, determining the weight to be applied when promotions are overlapping (i.e., the 0.7 in the above example) is non-trivial. First, the weight may be different from promotion to promotion. Further, the weight of promotion A in combination with promotion B may have the weight of 0.7, but the weight of promotion A in combination with promotion C, may be 0.6. Further, the weights are updated manually, which means that this a very time-consuming process. Because of the lengthy process, the values of the weights are not revisited on a timely fashion, which means that they can become stale after a while. Further, the user who manually updates the weights usually uses gut-feeling rather than analytics to come up with values, which may not lead to the most accurate forecasts.

One cause of the drawbacks described above is the fact that the independence assumption of the variables used in a linear regression algorithm does not always hold. In particular, in a retail-type of environment, where the promotional sales are modeled as being dependent of the baseline and a fixed number of independent promotions, the model needs to be augmented. In contrast, in embodiments of the present invention, additional linear regression variables are generated based on the overlapping promotions.

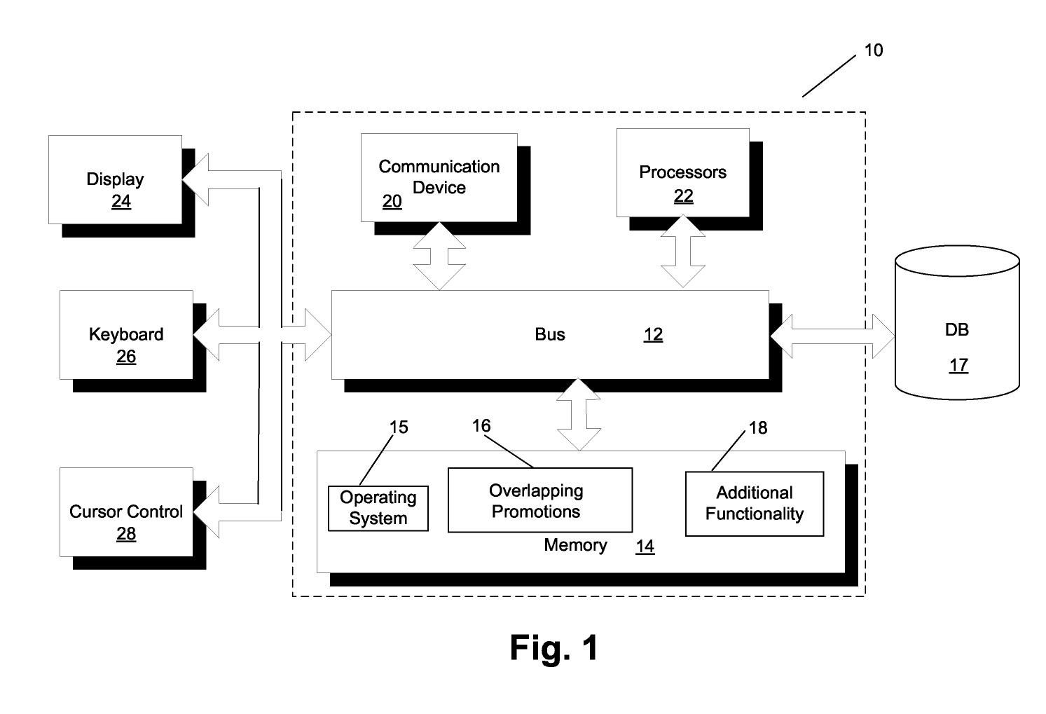

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a user client, system 10 may be a smartphone that includes a processor, memory and a display, but may not include one or more of the other components shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an overlapping promotions module 16 for determining the effects of overlapping promotions for retail forecasting, and all other functionality disclosed herein. System 10 can be part of a larger system. Therefore, system 10 can include one or more additional functional modules 18 to include the additional functionality, such as “Retail Demand Forecasting” from Oracle Corp. A database 17 is coupled to bus 12 to provide centralized storage for modules 16 and 18.

One embodiment provides a retail sales forecast that accounts for overlapping promotions or any type of overlapping promotion event to boost sales, or increase traffic in stores, or clear merchandise, or all of the above. To be able to forecast such actions, embodiments decouple the promotional sales from the baseline sales. Embodiments then model sales for a period t to equal baseline sales for period t plus the sum of all promotional lifts occurring in that period. Known linear regression techniques can then be used to determine the sales forecast.

As discussed, overlapping promotions occur when during a particular time period more than one promotion event is active, such as when an item is placed in the front of the store and is also advertised in a flyer, or when an item is discounted and is also advertised in an email “blast”. In the latter example, it is very difficult to assess what part of the promotional lift can be attributed to the discount and what part to the email notification. The problem becomes even harder when three or more promotion events are active at the same time. For instance, an item is in the front cap, is discounted, and is advertised in a flyer.

In order to account for overlapping promotions, embodiments examine historical demand from where promotions were active. As an example, the following may be the historical demand over 15 past time periods where two promotion events are active, “discount” and “email”:

| | | | | | | | | | | | | | | | |
|---|---|---|---|---|---|---|---|---|---|---|---|---|---|---|---|
| Period | 1 | 2 | 3 | 4 | 5 | 6 | 7 | 8 | 9 | 10 | 11 | 12 | 13 | 14 | 15 |

| | | | | | | |
|---|---|---|---|---|---|---|
| discount | [symbol] | X | | [symbol] | X | |
| email | [symbol] | | X | [symbol] | | X |

As shown, the item was discounted in periods 3, 6, 10, and 13. The item was advertised in an email in periods 3, 7, 10 and 14.

For periods where events are overlapping, embodiments create a new event ad-hoc to replace the overlap. This will correct for the very strong assumption that the events are independent.

| | | | | | | | | | | | | | | |
|---|---|---|---|---|---|---|---|---|---|---|---|---|---|---|
| Period | 1 | 2 | 3 | 4 | 5 | 6 | 7 | 8 | 9 | 10 | 11 | 12 | 13 | 14 |

| | | | | | | |
|---|---|---|---|---|---|---|
| discount | | X | | | X | |
| email | | | X | | | X |
| email + discount | [symbol] | | | [symbol] | | |

As shown, the item was discounted in periods 6 and 13, and was part of an email blast in periods 7 and 14. In addition, in periods 3 and 10, the new promotion event “email+discount” was active and replaces each individual discount and email promotion.

Embodiments then run linear stepwise regression to solve the equation modeling the process: Sales=baseline+sum of promotional lifts. The promotional lifts that are estimated are not just for the initial regression variables (i.e., initial events email and discount). Lifts are also estimated for the newly created overlapping promotion events regression variables (i.e., in the above example “email+discount”).

In one embodiment, the “causal”, or “promotional” forecasting used by Retail Demand Forecasting Release 13.4.1, from Oracle Corp., using the novel promotion events disclosed above is implemented. For example, embodiments receive three input streams: (1) Time Series Data; (2) Historical Promotional Calendar; and (3) Future Promotional Calendar. The problem of promotional forecasting is then decomposed into two subtasks: (1) Estimating the effect that promotions have on demand; and (2) Forecasting baseline (i.e., no promotions) demand. To accomplish the first task, a stepwise regression routine is used in one embodiment. This routine takes a time series and a collection of promotional variables and determines which variables are most relevant and what effect those relevant variables have on the series. Thus, the output from the algorithm is a selection of promotional variables and the effects of those variables on the series

In one embodiment, in matrix form the regression equation can be modeled as:

Y=X*B+noise;

where X and Y are the independent and dependent variables, respectively, with the dimensionalities being:

Y: n-by-1;

X: n-by-m;

B: m-by-1;

where “Y” represents the historical sales, and “X” represents the promotions, with “n” being the number of time periods for which sales and promotions are recorded. Vector B has “m” components, with the intercept representing the baseline, while the other “m−1” components represent the effects of the available promotions.

Embodiments then solve the linear regression model to generate the effects. As described, the equation to be solved is Y=X*B+noise, and the solution to the equation is: B=(X′*X)⁻¹*X′*Y.

In the above example, the results are as follows:
The discount promotion event accounts for 100 units if active by itself;
The email promotion event accounts for 50 units if active by itself; and
The email+discount promotion event accounts for 120 units.

Embodiments then forecast the baseline sales, which were not influenced by these changes. The baseline sales can be forecast using many known predictive techniques to generate forecasts of demand, including the predictive techniques used in “Retail Demand Forecasting” from Oracle Corp. Examples of predictive/forecasting techniques used in various embodiments include exponential smoothing forecasting, regression analysis forecasting, bayesian analysis forecasting, time series statistical forecasting, etc.

After the baseline sales is forecast, the promotion effects are applied accordingly. Continuing the previous example, consider the following promotion plan for future time periods 101-115 to be used for a sales forecast:

| | | | | | | | | | | | | | | | |
|---|---|---|---|---|---|---|---|---|---|---|---|---|---|---|---|
| period | 101 | 102 | 103 | 104 | 105 | 106 | 107 | 108 | 109 | 110 | 111 | 112 | 113 | 114 | 115 |

| | | | | | | |
|---|---|---|---|---|---|---|
| discount | X | X | | X | X | |
| email | X | | X | X | | X |

As shown, there will be a discount event in place for periods 103, 106, 110, and 113. There will be an email event in periods 103, 107, 110 and 114.

Given the promotion plan for the forecast horizon, the unit lifts/effects due to promotions are determined as follows:

| | | | | | | | | | | | | | | | |
|---|---|---|---|---|---|---|---|---|---|---|---|---|---|---|---|
| period | 101 | 102 | 103 | 104 | 105 | 106 | 107 | 108 | 109 | 110 | 111 | 112 | 113 | 114 | 115 |

| | | | | | | |
|---|---|---|---|---|---|---|
| discount | | 100 | | | 100 | |
| Email | | | 50 | | | 50 |
| email + discount | [symbol] | | | [symbol] | | |

As shown, for periods 103 and 110, the lift is not the 150 units (i.e., 100+50), but rather the lift estimated for the ad-hoc created email+discount promotion event (i.e., 120).

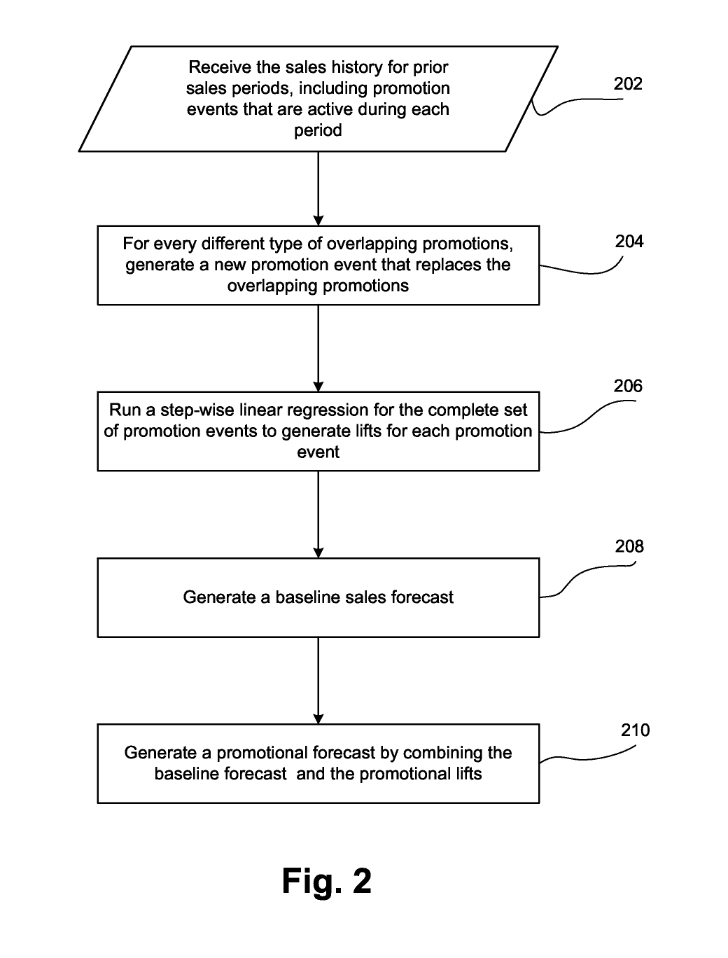

FIG. 2 is a flow diagram of the functionality of overlapping promotions module 16 of FIG. 1 when determining the effects of overlapping promotions for retail forecasting in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the sales history for prior sales periods is received. The sales history includes promotion events that are active during each period.

At 204, the promotion events in the sales history is reviewed, and for every different type of overlapping promotions, a new promotion event is generated that replaces the overlapping promotions. As a result, a complete set of promotion events is generated.

At 206, a step-wise linear regression is run for the complete set of promotion events generated at 204. As a result, the promotional lifts or promotional effect values are determined for each promotion event.

At 208, a baseline sales forecast is generated using known methods.

At 210, a promotional forecast is generated by combining the baseline forecast from 208 and the promotional lifts from 206. The generated promotional forecast provides a forecast of future sales that takes into account overlapping promotions.

In the simplified example disclosed above, only two promotion events are considered, A and B. However, in other embodiments, a larger number of promotion events are considered, which typically results in a large number of overlapping promotion events being generated. The following example involves more than two overlapping promotions.

Assume five promotion events, A-E, and four overlapping promotion events. After 206 of FIG. 2, the complete set of promotion events and corresponding promotion lifts/effects are as follows:

| promotion | eff |
|---|---|
| A | 1.0 |
| B | 1.2 |
| C | 2.2 |
| D | 1.0 |
| E | 1.5 |
| B + C | 2.5 |
| B + C + D | 3.1 |
| C + D | 2.1 |
| B + C + E | 2.8 |

The promotion indicators of the future horizon are:

| promotion | Week 1 | Week 2 | Week 3 | Week 4 | Week 5 | Week 6 |
|---|---|---|---|---|---|---|
| A | X | | | | | X |
| B | X | X | X | X | X | |
| C | X | X | X | | X | X |
| D | X | X | | X | | X |
| E | X | | X | | | X |

Embodiments sort significant overlapping promotions based on the number of promotions within the combination. If two combinations have the same number of promotions, embodiments sort by their effect value. From the above example, the order of overlapping promotions is: B+C+D, B+C+E, B+C, C+D.

Embodiments then, for each week, search the sorted overlapping promotions, find the first overlapping combination which is a subset of “on” promotions, mark it and replace the individual promotions:

| promotion | Week 1 | Week 2 | Week 3 | Week 4 | Week 5 | Week 6 |
|---|---|---|---|---|---|---|
| A | X | | | | | X |
| B | [symbol] | [symbol] | [symbol] | X | [symbol] | |
| C | [symbol] | [symbol] | [symbol] | | [symbol] | [symbol] |
| D | [symbol] | [symbol] | | X | | [symbol] |
| E | X | | [symbol] | | | X |
| B + C + D | [symbol] | [symbol] | | | | |
| B + C + E | | | [symbol] | | | |
| B + C | | | | | [symbol] | |
| C + D | | | | | | [symbol] |

Embodiments then apply promotion effects as disclosed above at 208 and 210 to generate a promotional forecast.

As disclosed, embodiments replace overlapping promotions with new overlapping promotion events. The lifts/effects from baseline sales for each new overlapping promotion event is that used as variables in a linear regression to generate a promotional forecast.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to generate a sales forecast for an item, the generating the sales forecast comprising:
receiving sales history for prior sales periods comprising active promotion events that are active during each sales period;
determining one or more types of overlapping promotions during the sales periods;
for each type of overlapping promotion, creating an overlapping promotion event that replaces the corresponding active promotion events;
generating a set of promotion events comprising the overlapping promotion events and the active promotion events that were not replaced; and
generating a lift for each of the promotion events in the set of promotion events.

2. The computer-readable medium of claim 1, the generating the sales forecast further comprising:
generating a baseline sales forecast; and
combining the lifts with the baseline sales forecast.

3. The computer-readable medium of claim 1, wherein the generating the lift comprises running a linear regression using each promotion event in the set of promotion events as variables.

4. The computer-readable medium of claim 1, wherein the active promotion events comprise at least one of: a price reduction, special placement in a store, or an advertisement.

5. The computer-readable medium of claim 1, wherein each type of overlapping promotions comprises a unique combination of active promotion events.

6. The computer-readable medium of claim 1, wherein the overlapping promotion event comprises a plurality of promotion events that are active during a same time period.

7. The computer-readable medium of claim 3, wherein the linear regression comprises a stepwise regression comprising receiving a time series and a collection of promotional variables and determining which variables are most relevant and what effect those relevant variables have on the time series.

8. A method for generating a sales forecast for an item, the method comprising:
receiving sales history for prior sales periods comprising active promotion events that are active during each sales period;
determining one or more types of overlapping promotions during the sales periods;
for each type of overlapping promotion, creating an overlapping promotion event that replaces the corresponding active promotion events;
generating a set of promotion events comprising the overlapping promotion events and the active promotion events that were not replaced; and
generating a lift for each of the promotion events in the set of promotion events.

9. The method of claim 8, further comprising:
generating a baseline sales forecast; and
combining the lifts with the baseline sales forecast.

10. The method of claim 8, wherein the generating the lift comprises running a linear regression using each promotion event in the set of promotion events as variables.

11. The method of claim 8, wherein the active promotion events comprise at least one of: a price reduction, special placement in a store, or an advertisement.

12. The method of claim 8, wherein each type of overlapping promotions comprises a unique combination of active promotion events.

13. The method of claim 8, wherein the overlapping promotion event comprises a plurality of promotion events that are active during a same time period.

14. The method of claim 10, wherein the linear regression comprises a stepwise regression comprising receiving a time series and a collection of promotional variables and determining which variables are most relevant and what effect those relevant variables have on the time series.

15. A retail sales forecasting system comprising:
a processor coupled to a storage device that implements an overlapping promotions module and a forecasting module;
the overlapping promotions module receives sales history for prior sales periods comprising active promotion events that are active during each sales period and determines one or more types of overlapping promotions during the sales periods;
the overlapping promotions module, for each type of overlapping promotion, creates an overlapping promotion event that replaces the corresponding active promotion events and generates a set of promotion events comprising the overlapping promotion events and the active promotion events that were not replaced; and
the forecasting module generates a lift for each of the promotion events in the set of promotion events.

16. The retail sales forecasting system of claim 15, the forecasting module generates a baseline sales forecast and combines the lifts with the baseline sales forecast.

17. The retail sales forecasting system of claim 15, wherein the generating the lift comprises running a linear regression using each promotion event in the set of promotion events as variables.

18. The retail sales forecasting system of claim 15, wherein the active promotion events comprise at least one of: a price reduction, special placement in a store, or an advertisement.

19. The retail sales forecasting system of claim 15, wherein each type of overlapping promotions comprises a unique combination of active promotion events.

20. The retail sales forecasting system of claim 15, wherein the overlapping promotion event comprises a plurality of promotion events that are active during a same time period.
